(19) United States
(12) Patent Application Publication
(10) Pub. No.: US 2005/0245347 A1
(43) Pub. Date: Nov. 3, 2005

(54) Driving device for an exerciser

(76) Inventor: Wu Chi Liang, Taichung County (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/838,727

(22) Filed: May 3, 2004

(51) Int. Cl. F16H 57/08

(52) U.S. Cl. 475/331

(57) ABSTRACT

A driving device for an exerciser includes a planet gear system secured on a frame of the exerciser. The planet gear system includes an inner gear mounted on the frame of the exerciser and a shaft pivotally centrally extending through inner gear. A rotor is securely mounted on the shaft and the shaft centrally extending through the rotor. At least two planet pinions is rotatably mounted to the rotor and respectively engaged to the inner gear. A flying wheel is pivotally mounted on the shaft and the shaft centrally pivotally extending through the flying wheel. The flying wheel includes a gear laterally centrally extending from the flying wheel and being used as a sun gear of the planet gear system. The gear is engaged to the at least two planet pinions.

### BACKGROUND OF THE INVENTION

1. Field of the Invention

The present invention relates to driving device, and more particularly to a driving device for an exerciser.

2. Description of Related Art

A conventional driving device for an exerciser in accordance with the prior art shown in FIG. 6 comprises an active wheel (60) pivotally mounted on a front portion of a main frame (70) of the exerciser and driving by the user. A magnetic wheel (80) is pivotally mounted on a rear portion of the main frame (70). A following wheel (62) is centrally laterally mounted to the magnetic wheel (80). An endless chain (60) is respectively coiled on the active wheel (61) and the following wheel (62) for driving the flying wheel (20). A magnetic-control device (81) is mounted on the main frame (70) and corresponds to an outer periphery of the magnetic wheel (80) Consequently, the load from the magnetic wheel (80) becomes heavy for providing an exercise effect to the user.

However, the active wheel (61) and the magnetic wheel (80) are respectively mounted on the front portion and the rear portion of the main frame (70) such that the volume of the exerciser is great and hard to be moved and stored.

The present invention has arisen to mitigate and/or obviate the disadvantages of the conventional driving device for an exerciser.

### SUMMARY OF THE INVENTION

The main objective of the present invention is to provide an improved driving device for an exerciser, which reduces the volume of the exerciser.

To achieve the objective, the driving device in accordance with the present invention comprises a planet gear system secured on a frame of the exerciser. The planet gear system includes an inner gear mounted on the frame of the exerciser and a shaft pivotally centrally extending through inner gear. A rotor is securely mounted on the shaft and the shaft centrally extending through the rotor. At least two planet pinions is rotatably mounted to the rotor and respectively engaged to the inner gear. A flying wheel is pivotally mounted on the shaft and the shaft centrally pivotally extending through the flying wheel. The flying wheel includes a gear laterally centrally extending from the flying wheel and being used as a sun gear of the planet gear system. The gear is engaged to the at least two planet pinions.

Further benefits and advantages of the present invention will become apparent after a careful reading of the detailed description with appropriate reference to the accompanying drawings.

### BRIEF DESCRIPTION OF THE DRAWINGS

FIG. 1 is a cross-sectional view of a driving device for a exerciser in accordance with the present invention;

FIG. 2 is a partially cross-sectional view of the driving device in FIG. 1 along line 2-2;

FIG. 3 is a schematic view of the driving device in FIG. 1;

FIG. 4 is a partially cross-sectional view of a second embodiment of the driving device of the present invention;

FIG. 5 is a schematic view of the driving device in FIG. 4; and

FIG. 6 is a side plan view of a conventional driving device for an exerciser in accordance with the prior art.

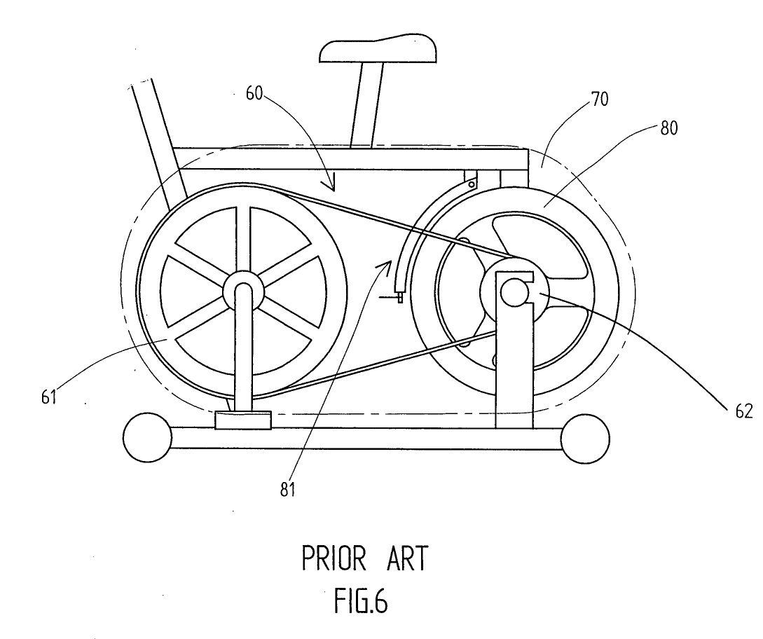

### DETAILED DESCRIPTION OF THE INVENTION

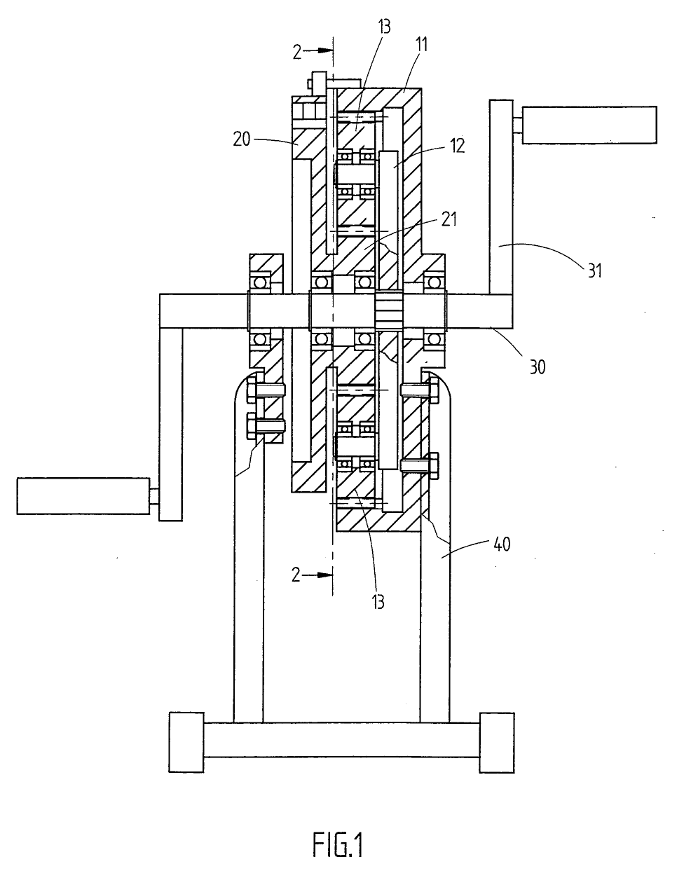

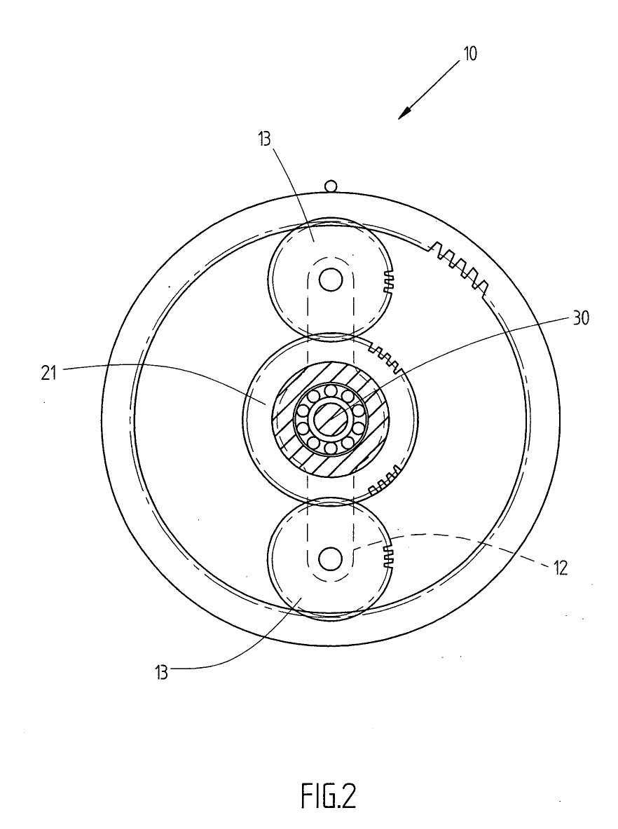

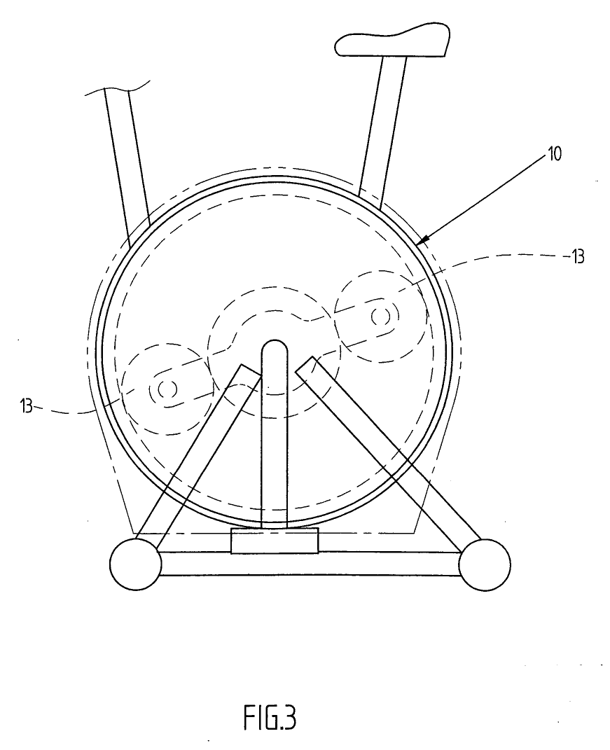

Referring to the drawings and initially to FIGS. 1-3, a driving device for an exerciser in accordance with the present invention comprises a planet gear system (10) adapted to be mounted on a frame (40) of the exerciser, a flying wheel (20) laterally centrally connected to the planet gear system (10), and a shaft (30) laterally centrally extending through the planet gear system (10) and the flying wheel (20) for driving the planet gear system (10).

The planet gear system (10) includes an inner gear (11) adapted to be mounted on the frame (40) of the exerciser and a rotor (12) secured on the shaft (30). The shaft (30) centrally extends through the rotor (30). Two planet pinions (13) are respectively rotatably secured on the rotor (12) and engaged to the inner gear (11). The two planet pinions (13) diametrically correspond to each other relative to the inner gear (11).

The flying wheel (20) is rotatabe relative to the shaft (30) and has a sun gear (21) laterally centrally extending from the flying wheel (20). The sun gear (12) is engaged to the two planet pinions (13).

The shaft (30) has two opposite ends each having a crank (31) mounted thereon. Each crank (31) includes a free end having a pedal mounted thereon for user to easily operate the shaft (30) and the planet gear system (10) for driving the flying wheel (20).

The two planet pinions (13) is in a condition of rotation and revolution when the shaft (30) is rotated to drive the rotor (12). The flying wheel (20) with the sun gear (21) is driven by the rotating planet pinions (13) and a ratio is formed among the inner gear (11), the rotor (12) and the sun gear (21) to achieve the objective of exercise.

In addition, all elements of the driving device in accordance with the present invention are co-axial relative to one another. Consequently, the total length of the exerciser is shortened. For user to easily move and store the exerciser.

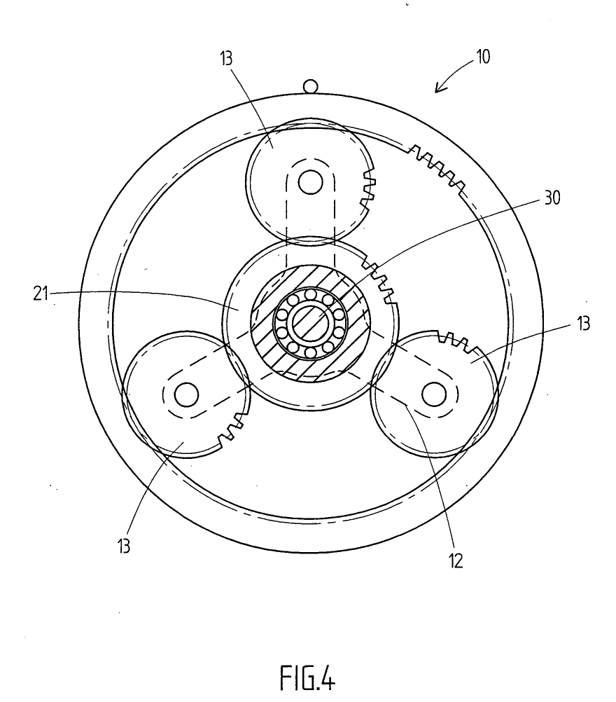

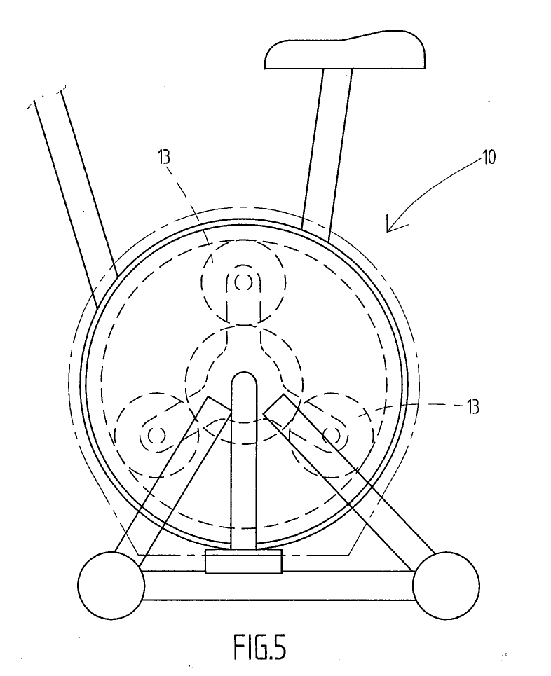

With reference to FIGS. 4 and 5 that show a second embodiment of the driving device of the present invention, the planet gear (10) includes three planet pinions (13) respectively pivotally mounted on the rotor (12) and engaged to the inner gear (11), and equally dividing an inner periphery of the inner gear (11) into three portions.

Although the invention has been explained in relation to its preferred embodiment, it is to be understood that many other possible modifications and variations can be made without departing from the spirit and scope of the invention as hereinafter claimed.

1. A driving device for an exerciser, comprising:
a planet gear system adapted to be secured on a frame of the exerciser, the planet gear system including:
an inner gear adapted to be mounted on the frame of the exerciser;
a shaft pivotally centrally extending through inner gear;
a rotor securely mounted on the shaft and the shaft centrally extending through the rotor; and
at least two planet pinions rotatably mounted to the rotor and respectively engaged to the inner gear; and
a flying wheel pivotally mounted on the shaft and the shaft centrally pivotally extending through the flying wheel, the flying wheel including a gear laterally centrally extending from the flying wheel and being used as a sun gear of the planet gear system, the gear engaged to the at least two planet pinions.

2. The driving device as claimed in claim 1, wherein the planet gear system includes two planet pinions diametrically corresponding to each other.

3. The driving device as claimed in claim 1, wherein the planet gear system includes three planet pinions equally dividing an inner periphery of the inner gear into three portions.
